(19) United States
(12) Patent Application Publication
(10) Pub. No.: US 2012/0255628 A1
(43) Pub. Date: Oct. 11, 2012

(54) CHECK VALVE ACCESS CHAMBER

(75) Inventors: Payk Pourzynal, Ottawa (CA); Mark Girimonte, North Gower (CA); James Henderson, Gatineau (CA); Kevin J. Bailey, Ottawa (CA)

(73) Assignee: Back Water Boot Inc., Ottawa (CA)

(21) Appl. No.: 13/440,739

(22) Filed: Apr. 5, 2012

Related U.S. Application Data
(60) Provisional application No. 61/516,553, filed on Apr. 5, 2011.

(51) Int. Cl. E03F 7/04; F16K 51/00

(52) U.S. Cl. 137/371; 137/15.18; 29/897.3

(57) ABSTRACT

A check valve access chamber is provided that is capable of forming a sealed enclosure against or around a self-contained check valve assembly so as to maintain a continuous barrier against moisture, waste water, and sewage gases during normal operation or under backflow situations. The access chamber may also include an angled floor and/or angled pipe flanges to add or maintain a grade across the sewer pipe or the self-contained check valve assembly to ensure adequate flow to meet or exceed building code standards. Access chambers of this type permit a labour-saving method of installing a check valve comprising the steps of connecting an access chamber having an access sleeve to a self-contained check valve assembly; connecting the self-contained check valve assembly to an inlet pipe and an outlet pipe; backfilling around the access chamber to a desired grade; and trimming the access sleeve to a desired height relative to the desired grade.

### CROSS-REFERENCE TO RELATED APPLICATION

This application claims the benefit under Title 35 U.S.C. 119(e) of U.S. Provisional Application No. 61/516,553 filed on Apr. 5, 2011, which is herein incorporated by reference.

### BACKGROUND OF THE INVENTION

1. Field of the Invention

The present invention relates to access chambers for check valve assemblies and methods of installing access chambers for check valve assemblies.

2. Description of the Prior Art

Changing climate patterns have had some unfortunate deleterious effects for home owners. One such effect is basement flooding, which has become more of a common occurrence as older homes age and suburbs grow. Flooding causes impacts beyond property damage. For example, a moist living environment may cause respiratory problems triggered by mould and dust. Additionally, frequent flooding may cause long-term damage to foundations. Repeated flooding can also have other long-term financial consequences, such as increased insurance rates and devaluation of a property.

Municipal sewer systems are designed to limit the likelihood of flooding. In most municipal systems, a sanitary sewer transports waste water from homes. Such waste water may include ground water from weeping tile that surround a home's foundation. During periods of heavy rainfall or when snow is melting, municipal sewer systems may become overloaded, causing surcharge. If a home has sanitary fixtures or floor drains below the surcharge level, basement flooding can occur.

There are various methods for preventing the resulting sewer backup. One such device is a check valve that automatically closes if there is a reversal of flow in the sewer line. In an open position, such valves permit the flow of waste outward and into the municipal sewer system. Sewer check valves are so effective that many municipalities have or are considering making them mandatory under local building codes and/or providing grants to home owners who choose to install them.

A variety of check valve assemblies suitable for the protection of residential and commercial sewer lines are known in the art. In North America, the industry standard is currently the Mainline Fullport™ Backwater Valve Model #4963 sold by Mainline Backflow Products Inc. and described in U.S. Pat. No. 5,406,972 to Coscarella. This self-contained check valve assembly provides backflow protection which can be installed on the main sewer line to protect the entire drain system against backflow events.

In addition, the manner in which a check valve is installed can affect the septic flow when the valve is in an open position. Some municipal authorities require the valve to be installed at a grade of two degrees relative to level so that there is a slight gravitational pull upon the waste water as it flows outward. The requirement to incorporate the grade adds time and effort to the installation process, especially for a retrofit installation. In this circumstance, the installer must expose a sufficient length of pipe (four or five feet) so that the grade of the pipe can be made uniform. Increasing the grade at which the check valve is installed above two degrees would require the exposure of an even greater length of pipe.

Since most main sewer lines reside underground, the installation of a check valve assembly in a main sewer line means that a sewer check valve assembly typically resides underground, often below a finished grade. Once a sewer check valve is installed, there must be a means to access the check valve assembly for cleanout, repair, and maintenance of its components. This is necessary to address any build up of debris within the valve's primary housing, which can interfere with flappers, floats, and other check valve components.

Concrete or masonry pits and manholes are traditionally used to provide an access chamber for sewer check valves to permit cleaning, repair, and maintenance. However, these approaches greatly increase the costs associated with installation. Manholes are prohibitively expensive in many applications, whereas concrete and masonry pits require additional labour that often necessitates multiple visits by multiple tradespeople to complete an installation.

Concrete and masonry pits are particularly common where check valves are installed in sewer lines residing underneath a finished basement floor of a residential or commercial structure. Such pits provide inadequate protection against water seepage into the access chamber, particularly when the ground is saturated during a flooding or backflow event. If backflow is encountered and the valve closes, effluent may escape through the pit and into the basement.

One alternative to pits and manholes is to use an access box that is lowered around the self-contained check valve assembly so that the lid of the box is flush with the basement floor. The lid of the access box can then be opened as required to permit access to the check valve assembly from the finished grade. Such an access box is depicted at the website located at the URL http://www.backwatervalve.ca/mainline-access-spec.html. A schematic showing the check valve assembly and the access box around it is depicted at the website located at the URL http://www.backwatervalve.ca/mainline-installation.html. It will be seen from this schematic that the access box has no bottom to prevent ground water and debris from accessing the valve or to contain any effluent that may escape through the access hole. Indeed, where such access boxes are utilized, municipal authorities require that cement be poured around the check valve to limit the upward percolation of moisture by creating a continuous barrier along the floor of the building. This solution therefore also provides inadequate protection against water seepage into the access chamber.

Another alternative is provided in Canadian patents 2,202,214 and 2,420,444 to Watts, which provide an inspection chamber that incorporates check valve components. Inspection chambers are typically installed where the sanitary sewer outlet from a building joins the sewer main and are used to seal the building's sewer system until it is inspected and approved. In both patents to Watts, the sealing plug in the inspection chamber can be replaced with a removable flapper element, which converts the inspection chamber into a check valve. Access to the flapper element is provided from the finished grade by a specialized tool and a long access pipe. The access pipe is sealed at the top via a locking lid to contain fluids and sewer gasses. Thus, the device in Watts is a single unit which serves as both an inspection chamber and a check valve assembly. However, the Watts device is not well-suited for indoor installations since sewer gasses and/or sewage are permitted to enter into the access pipe. This can be problematic for installations below ground level when pressure and fluid levels rise in the sewer system during a backup event. Furthermore, the system in Watts is intended to double as an inspection chamber and as such, is typically installed outdoors at a point near the city sewer main at a location accessible to building inspectors and other qualified personnel. Finally, the device in Watts provides its own check valve components and cannot readily be adapted to work with check valve assemblies from other manufacturers.

Another single-unit device is described in U.S. Pat. No. 5,234,018 to Grachal et al. The Grachal device has an inverted T-shaped valve body in which the upright portion of the T receives an internal riser. One end of the internal riser includes a flapper mount and flapper, which forms a check valve when the internal riser is inserted in the valve body. As in Watts, sewage and sewer gasses are permitted to enter the access portion of the device, which can pose issues in indoor installations. Similarly, the device in Grachal provides its own check valve components and cannot readily be adapted to work with check valve assemblies from other manufacturers.

### SUMMARY OF THE INVENTION

The invention contemplated herein provides a check valve access chamber capable of forming a sealed enclosure against or around a self-contained check valve assembly so as to maintain a continuous barrier against moisture, waste water, and sewage gases during normal operation or under backflow situations.

The check valve access chamber includes a housing pan sealably connectable to a self-contained check valve assembly and an access sleeve capable of being trimmed to a variable length, which is sealably connectable to the housing pan in a substantially upright orientation and provides access to the self-contained check valve assembly.

In some embodiments, the sealable connection between the housing pan and the self-contained check valve assembly is facilitated by a pan seal between the housing pan and the check valve assembly. In other embodiments, the sealable connection between the housing pan and the self-contained check valve assembly is facilitated by a sealed enclosure formed by the housing pan around the self-contained check valve access chamber.

Embodiments which connect to the self-contained check valve assembly via a sealed enclosure around the check valve assembly include a housing pan for supporting a self-contained check valve assembly, a first aperture disposed on a first side of the housing pan for receiving an inlet pipe, a second aperture disposed on a second side of the housing pan for receiving an outlet pipe, and an access sleeve capable of being trimmed to a variable length connected to the housing pan in a substantially upright orientation for providing access to the self-contained check valve assembly. Thus, the housing pan and the access sleeve form a sealed enclosure around the self-contained check valve assembly.

In some embodiments which connect to the self-contained check valve access chamber via a sealed enclosure around the check valve assembly, the invention contemplated herein also includes an angled floor and/or angled pipe flanges to add or maintain a grade across the sewer pipe or the self-contained check valve assembly to ensure adequate flow to meet or exceed building code standards.

An access chamber according to the invention contemplated herein permits a labour-saving method of installing a check valve comprising the steps of connecting an access chamber having an access sleeve to a self-contained check valve assembly; connecting the self-contained check valve assembly to an inlet pipe and an outlet pipe; backfilling around the access chamber to a desired grade; and trimming the access sleeve to a desired height relative to the desired grade.

Descriptive references herein such as “front”, “left”, “right”, “top”, “bottom”, “level”, “upright”, “parallel”, “perpendicular”, “straight”, “horizontal”, “vertical”, or “opposite” are for convenience of description only. It will be appreciated by one skilled in the art that the placement of an element may depart moderately from these configurations.

### BRIEF DESCRIPTION OF THE DRAWINGS

These and other objects and advantages of the invention contemplated herein will become apparent upon reading the following detailed description and upon referring to the drawings, which illustrate, by way of example only, embodiments of the invention contemplated herein:

FIGS. 1 and 2 provide a perspective and exploded view, respectively, of an embodiment of the present invention.

FIGS. 3 and 4 provide a front view and cross-sectional view, respectively, of the embodiment depicted in FIGS. 1 and 2.

FIGS. 5-8 provide a top, bottom, left, and right view, respectively, of the embodiment depicted in FIGS. 1 and 2.

FIGS. 9-10 provide a perspective and exploded view, respectively, of another embodiment of the present invention.

FIGS. 11-12a provide a front view and cross-sectional view, respectively, of the embodiment depicted in FIGS. 9 and 10.

FIG. 12b provides an enlarged cross-sectional scrap view of the area highlighted in box 12b of FIG. 12a.

FIGS. 13-16 provide a top, bottom, left, and right view, respectively, of the embodiment depicted in FIGS. 9 and 10.

FIGS. 17-18 provide a perspective and exploded view, respectively, of another embodiment of the present invention.

FIGS. 19-20a provide a front view and cross-sectional view, respectively, of the embodiment depicted in FIGS. 17 and 18.

FIG. 20b provides an enlarged cross-sectional scrap view of the area highlighted in box 20b of FIG. 20a.

FIGS. 21, 22, 23a, and 23b provide a top, bottom, left, and right view, respectively, of the embodiment depicted in FIGS. 17 and 18.

FIG. 24 provides a partly exploded perspective view in which various parts have been removed for clarity.

FIGS. 25-26 provide a perspective and exploded view, respectively, of another embodiment of the present invention.

FIGS. 27-28 provide a front view and cross-sectional view, respectively, of the embodiment depicted in FIGS. 25 and 26.

FIGS. 29-32 provide a top, bottom, left, and right view, respectively, of the embodiment depicted in FIGS. 25 and 26.

FIGS. 33-34 provide a perspective and exploded view, respectively, of another embodiment of the present invention.

FIGS. 35-36 provide a front view and cross-sectional view, respectively, of the embodiment depicted in FIGS. 33 and 34.

FIGS. 37-40 provide a top, bottom, left, and right view, respectively, of the embodiment depicted in FIGS. 33 and 34.

FIGS. 41-42 provide a perspective and exploded view, respectively, of another embodiment of the present invention.

FIGS. 43-44 provide a front view and cross-sectional view, respectively, of the embodiment depicted in FIGS. 41 and 42.

FIGS. 45-48 provide a top, bottom, left, and right view, respectively, of the embodiment depicted in FIGS. 41 and 42.

FIG. 49 illustrates several methods according to the present invention. Branches indicate alternative paths. Arrows marked in dashed lines represent optional steps which may be omitted from the method.

### DETAILED DESCRIPTION OF THE PREFERRED EMODIMENTS

Referring now to the drawings, various embodiments of access chambers and methods according to the present invention are disclosed.

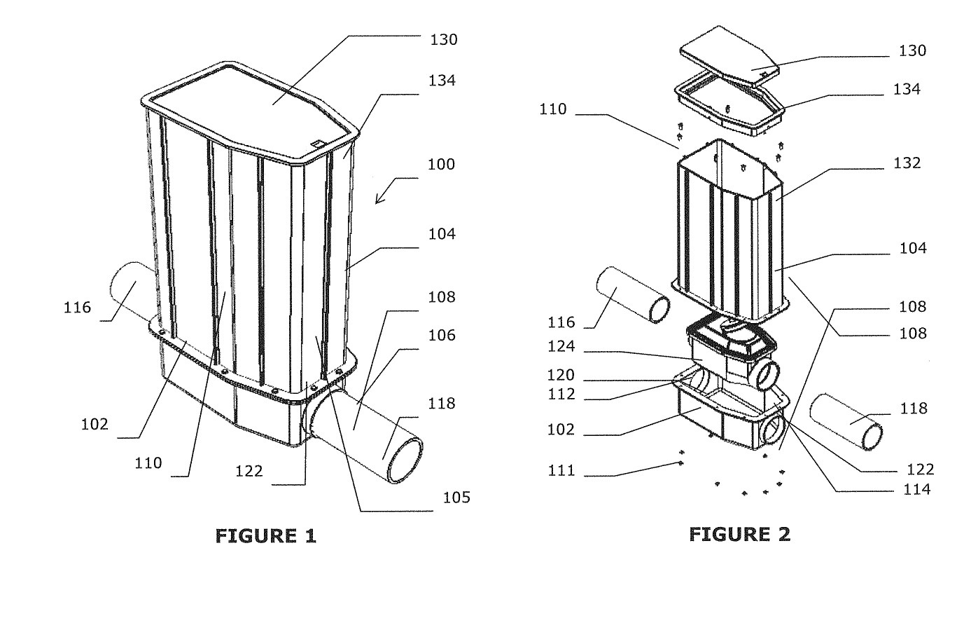

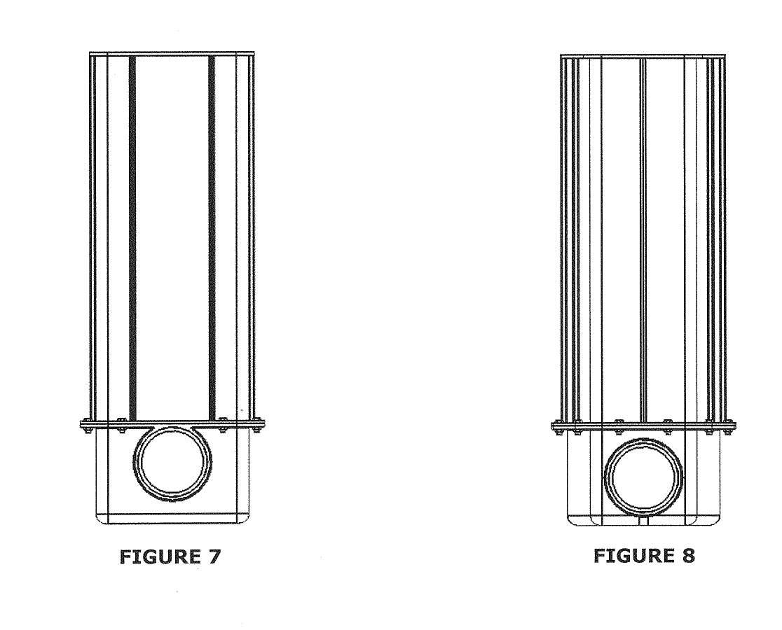

FIGS. 1 through 8 provide a check valve access chamber 100 according to one embodiment of the invention contemplated herein. In this embodiment, the self-contained check valve assembly 124 is connected to the access chamber 100 by forming a sealed enclosure around the self-contained check valve assembly 124. As can be seen in FIG. 1 and FIG. 2, the check valve access chamber 100 comprises a housing pan 102 and an access sleeve 104.

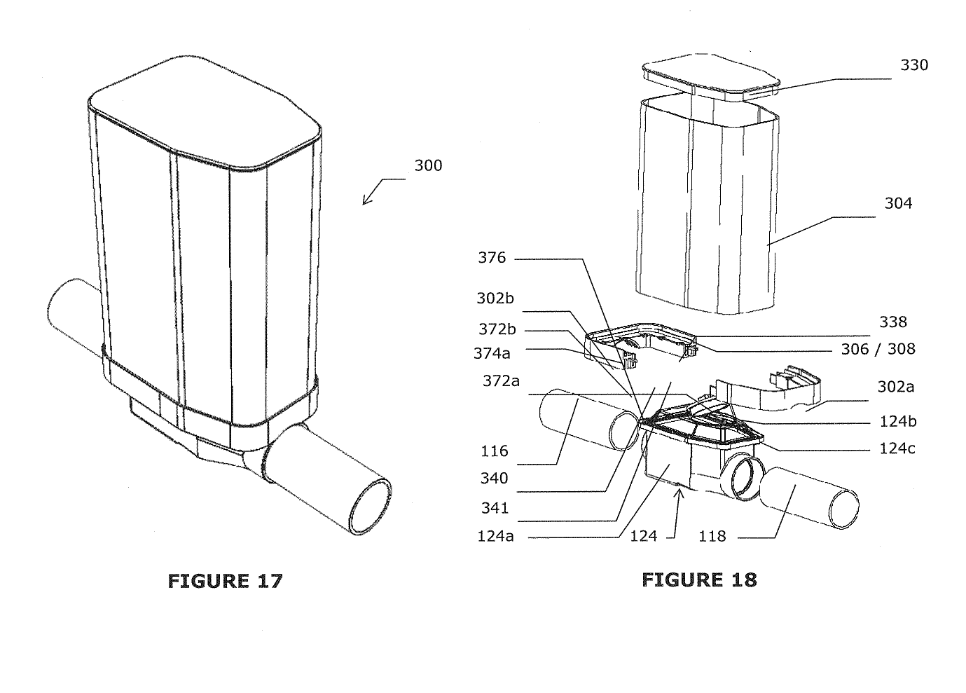

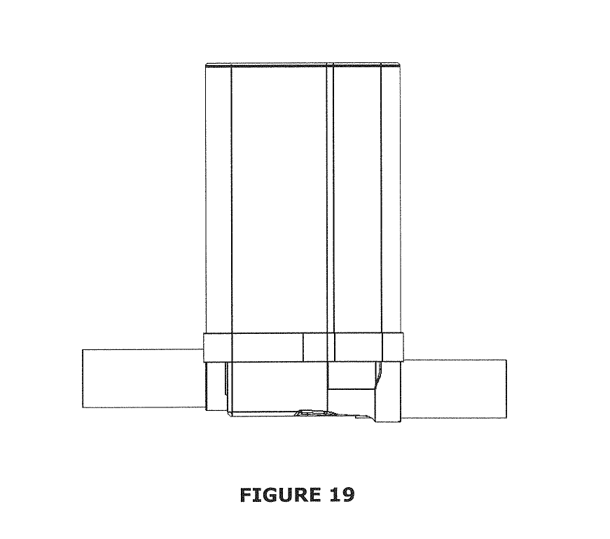

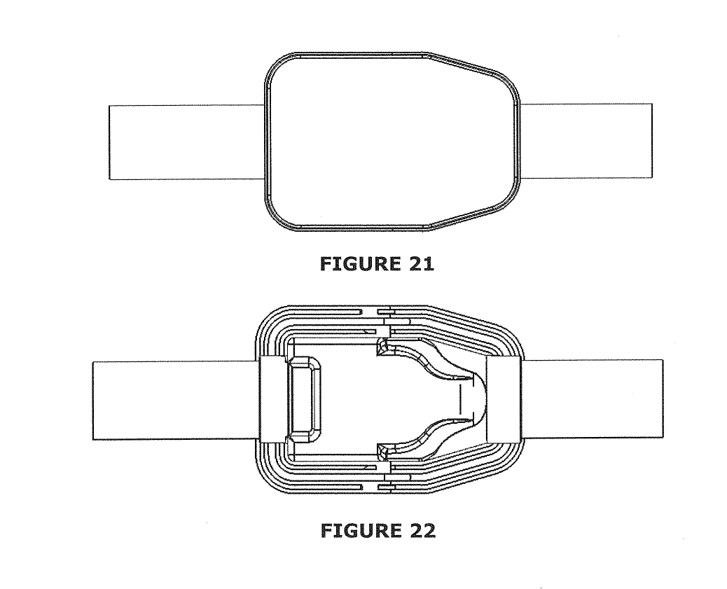

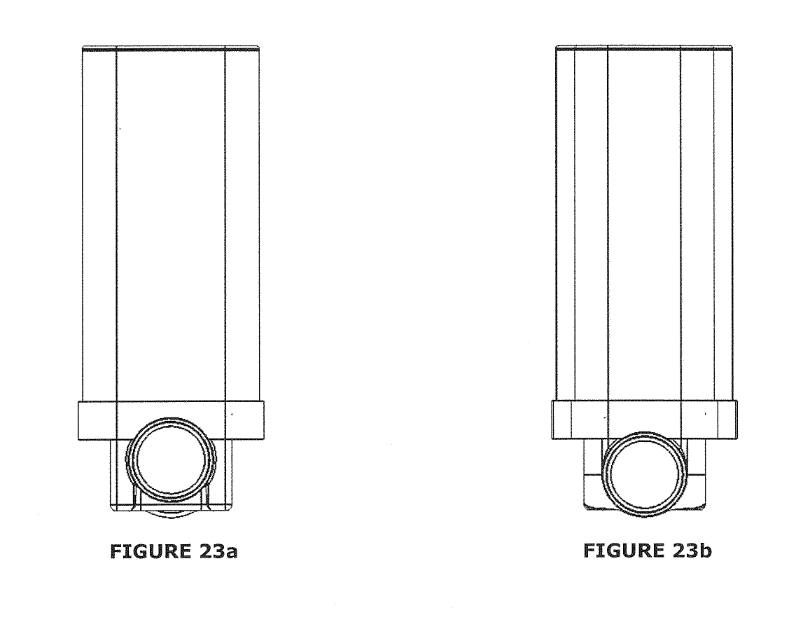

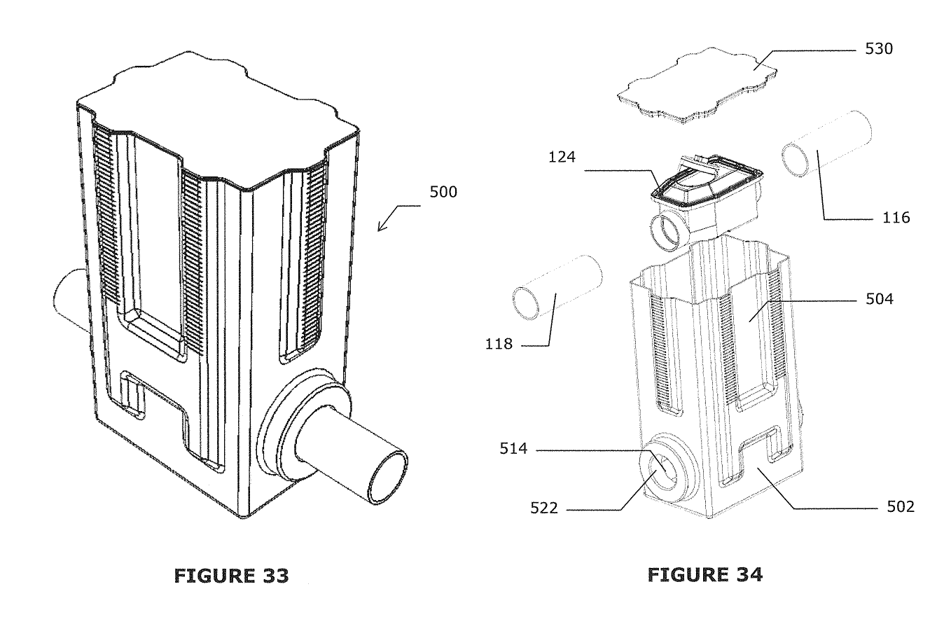

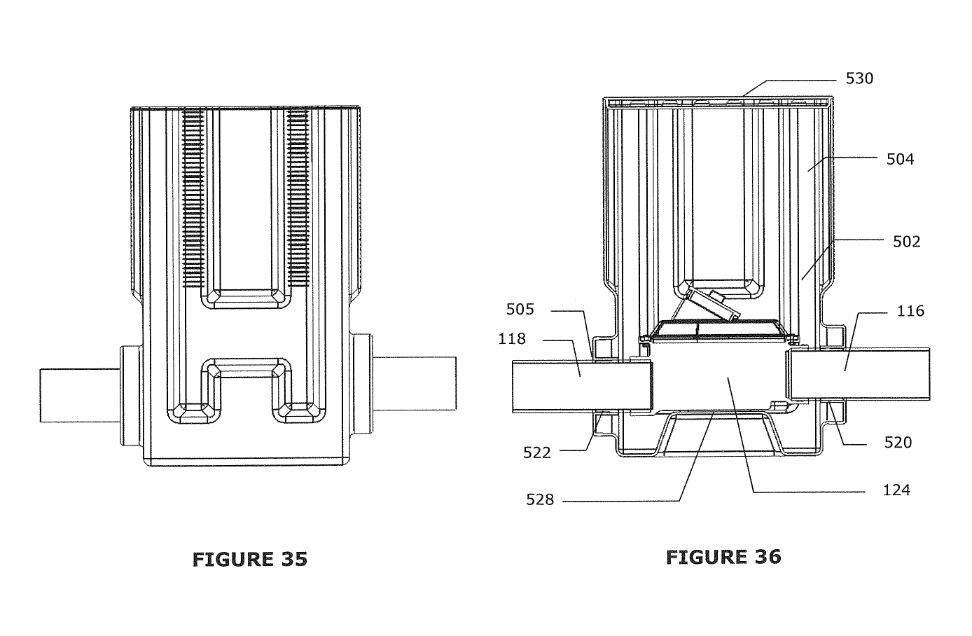

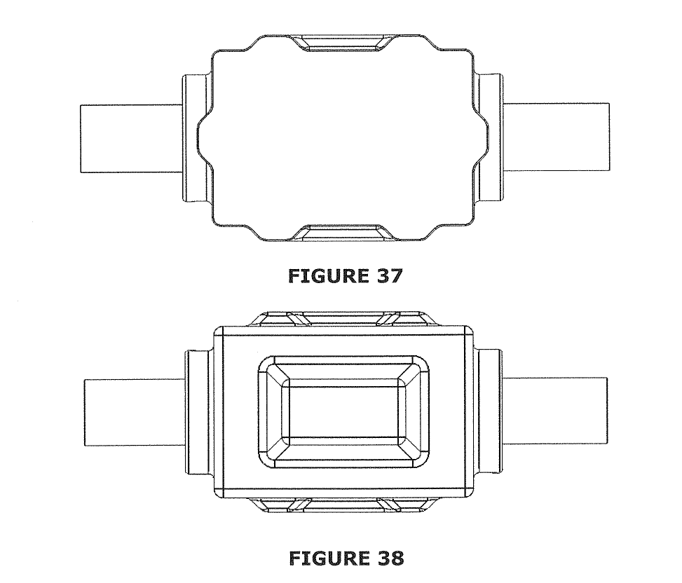

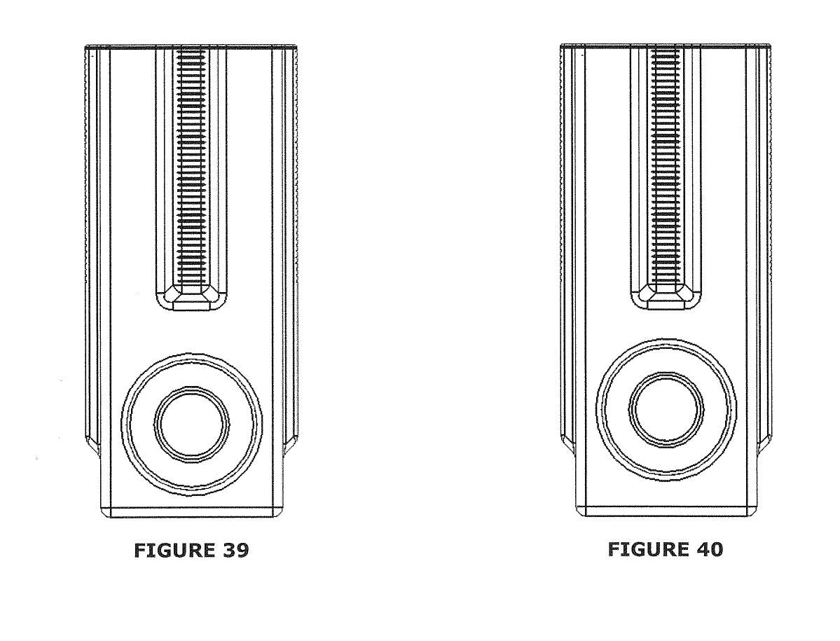

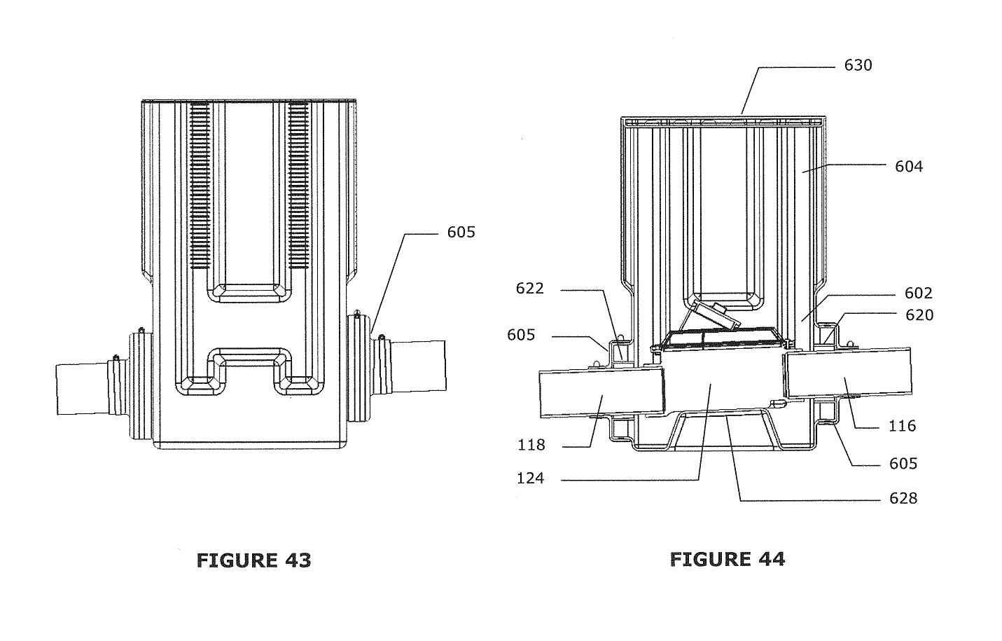

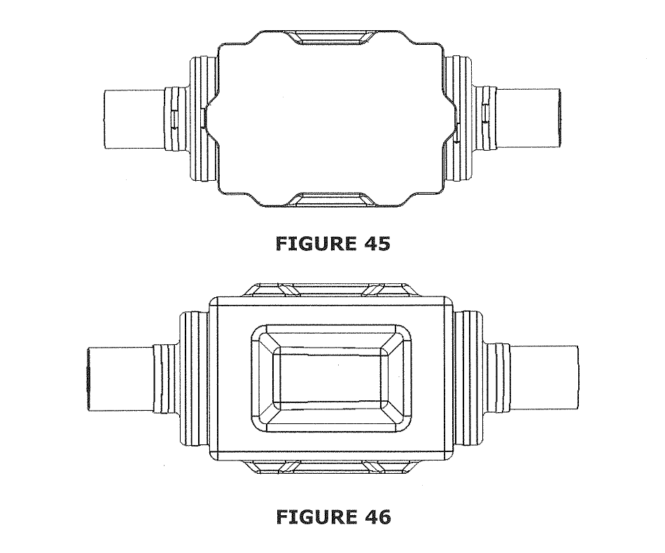

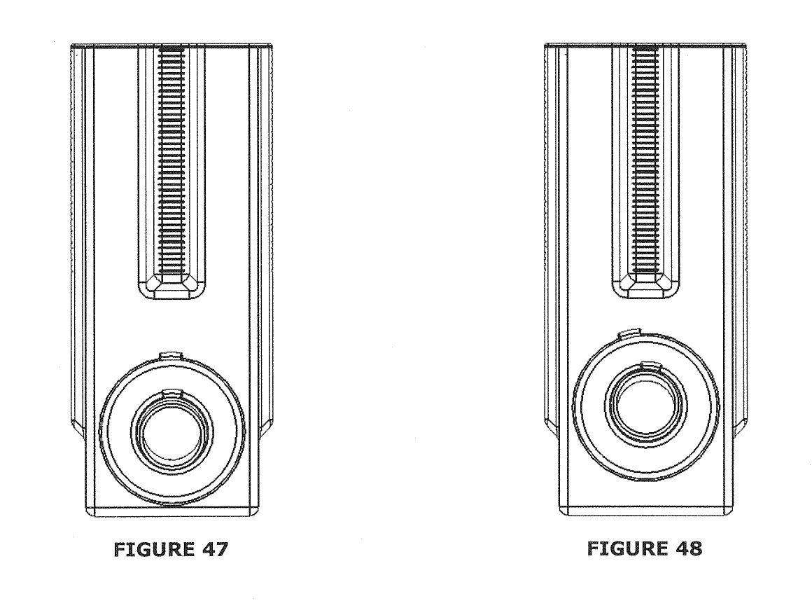

The housing pan 102 and access sleeve 104 are provided as two pieces that are joined at a sleeve seal 106. In this embodiment, the sleeve seal 106 is provided by sleeve seal flanges 108 which are fastened together using bolts 110 and nuts 111 and may optionally include a gasket (not shown). Various other types of sleeve seals are contemplated. For example, in some embodiments, such as check valve access chamber 300 (FIGS. 17-24), the sleeve seal 306 is formed by applying caulking or other adhesives along sleeve seal flanges 308. Other types of seals are known in the art and could readily be applied to form a sleeve seal. Furthermore, it is also contemplated to provide a housing pan 102 and access sleeve 104 as a single integral unit, as depicted in check valve access chambers 500 and 600 shown in FIGS. 33-40 and FIGS. 41-48 respectively, which are described below.

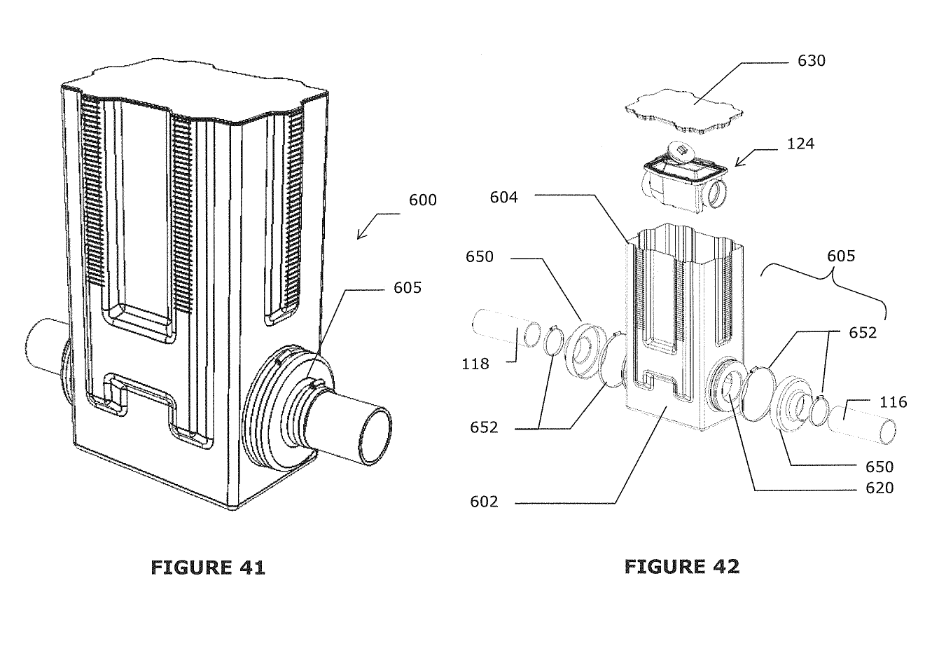

In check valve access chamber 100, the sides of the housing pan 102 are provided with a first aperture 112 and a second aperture 114, which in this embodiment are located on opposite ends of the housing pan 102. The first aperture 112 is dimensioned so as to receive an inlet pipe 116 from the building's plumbing system. The second aperture 114 is dimensioned so as to receive an outlet pipe 118 to the sewer main. Preferably, both apertures are sealed against their respective pipes at a pipe seal 105. In check valve access chamber 100, the pipe seal 105 is formed by first and second pipe flanges 120 and 122 disposed along the first and second apertures 114 and 118 respectively, which are secured to the pipe using a connecting means such as an adhesive. In other embodiments, such as check valve access chamber 600 (FIGS. 41-48), described below, the pipe seals 605 are formed at the first and second apertures 612 and 614 by flexible rubber caps 650 secured by pipe clamps 652. A variety of other pipe seals are contemplated as part of the invention, including pressure fittings, gaskets, or screw threads.

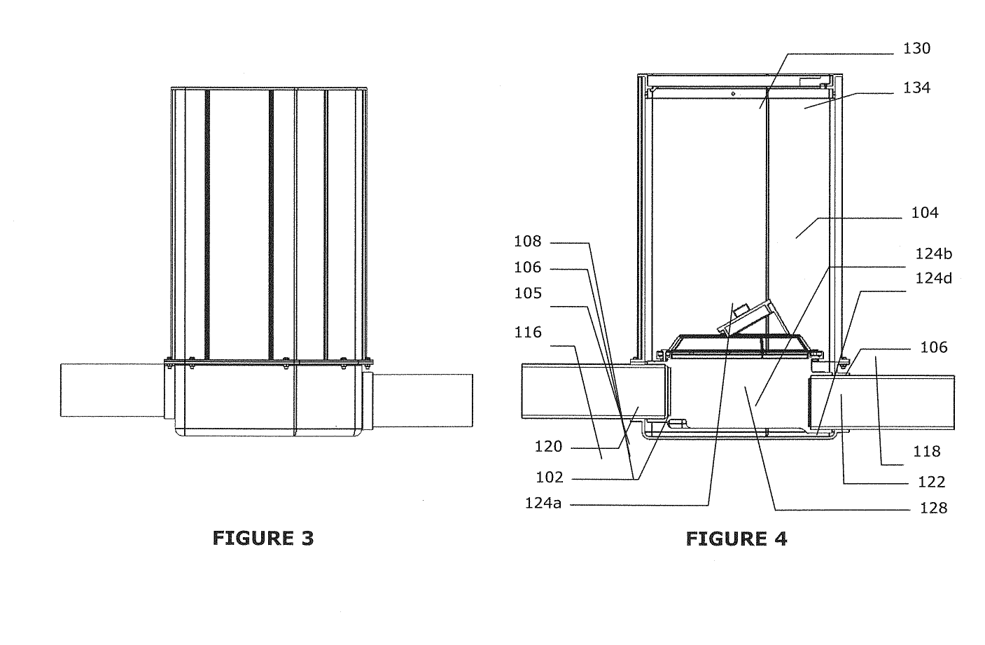

Turning now to FIG. 3, it can be seen that the first and second pipe flanges 120, 122 in check valve access chamber 100 are substantially perpendicular to the sides of the housing pan 102. However, in other embodiments, such as check valve access chamber 600 (FIGS. 41-48), described below, the first and second pipe flanges 620, 622 are provided at an angle, such that a grade is maintained across the inlet pipe 116 and the outlet pipe 118. This grade is preferably between 2-4%.

In check valve access chamber 100, the housing pan 102 is dimensioned so as to support a self-contained check valve assembly 124. Check valve assemblies are known in the art and are shown in the figures for illustrative purposes. The self-contained check valve assembly 124 shown in the figures is a Mainline Fullport™ Backwater Valve Model #4963 sold by Mainline Backflow Products (Can) Inc. and described in U.S. Pat. No. 5,406,972 to Coscarella. As can be readily understood by a person of skill in the art, the invention contemplated herein can also be adapted for use with other models and brands of self-contained check valve assembly 124.

A self-contained check valve assembly 124 includes a primary valve housing 124a and usually has a removable valve lid 124b used to access the valve components for maintenance and repair. The Mainline Fullport™ Backwater Valve further includes a valve lip 124c at the juncture between the primary valve housing 124a and the valve lid 124b. Such lips can also be found on other models and brands of self-contained check valve assembly 124. The valve lid 124b and the primary valve housing 124a are sealed by a valve lid seal 124d, which provides a seal against sewer gasses and waste water.

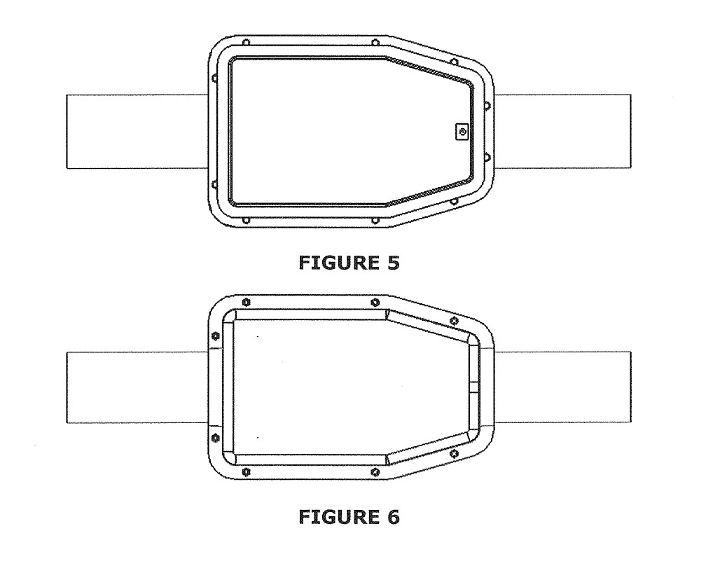

In check valve access chamber 100, the self-contained check valve assembly 124 is supported in the housing pan 102 by the housing pan floor 128. In this embodiment, the housing pan floor 128 has a flat configuration (FIG. 4). In other embodiments, such as check valve access chamber 600 (FIG. 44), the housing pan floor 628 has an angled configuration. In the angled configuration, the inlet side of the self-contained check valve assembly 124 is raised relative to the outlet side, thereby creating a grade which is in addition to any grade built in to the self-contained check valve assembly 124. This grade is preferably between 2-4%. Optionally, the self-contained check valve assembly may also be mounted to the housing pan floor 128 using glue, screws, nuts and bolts, or any other suitable attachment means (not shown).

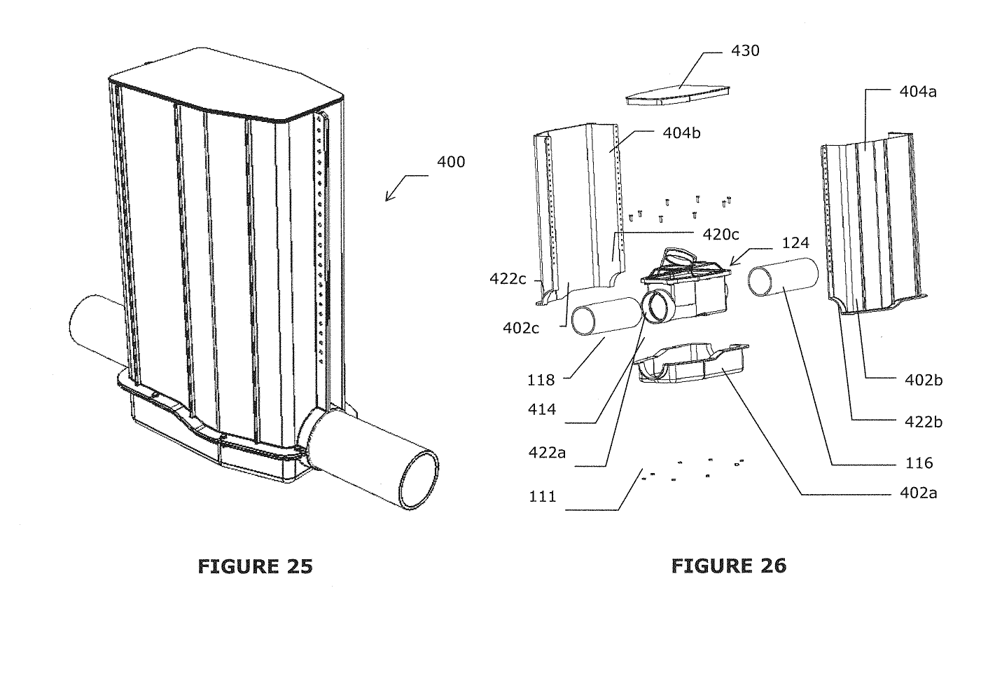

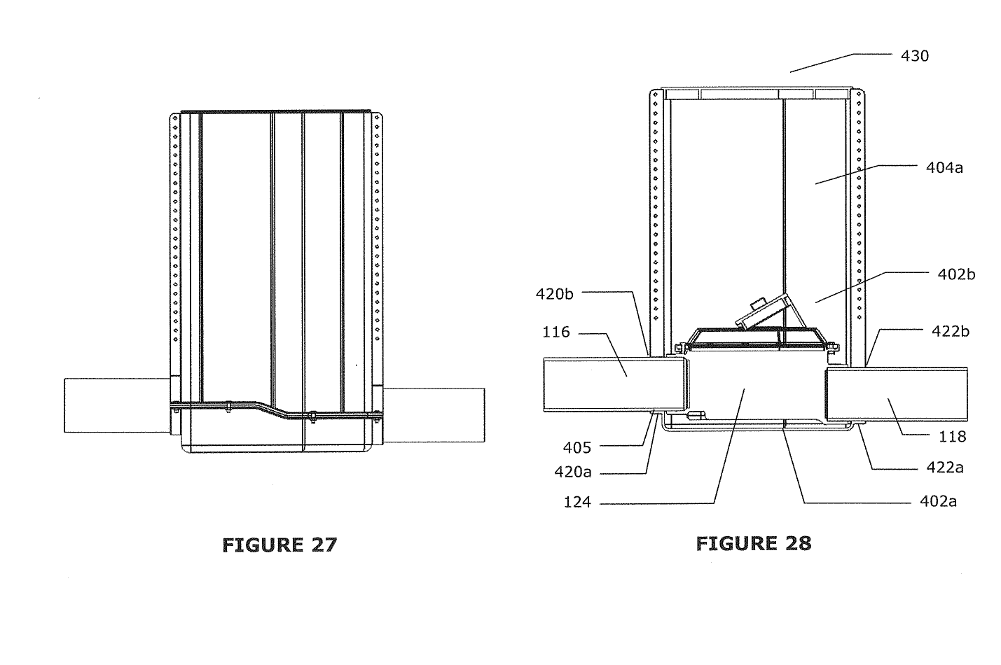

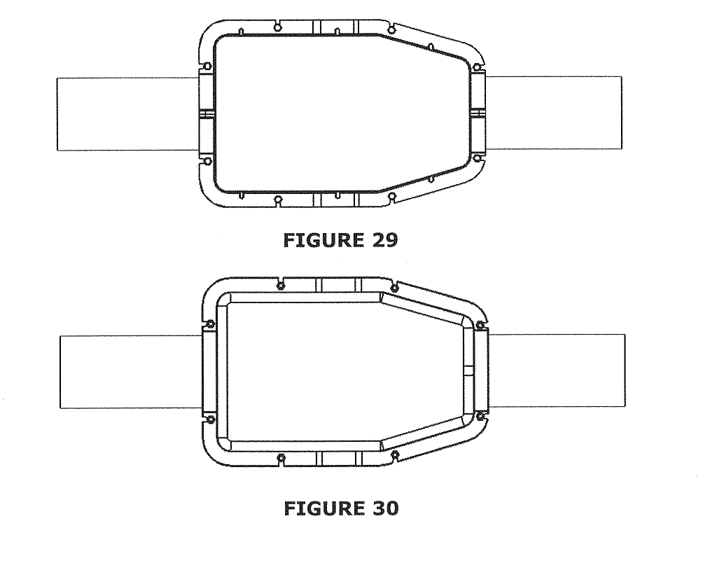

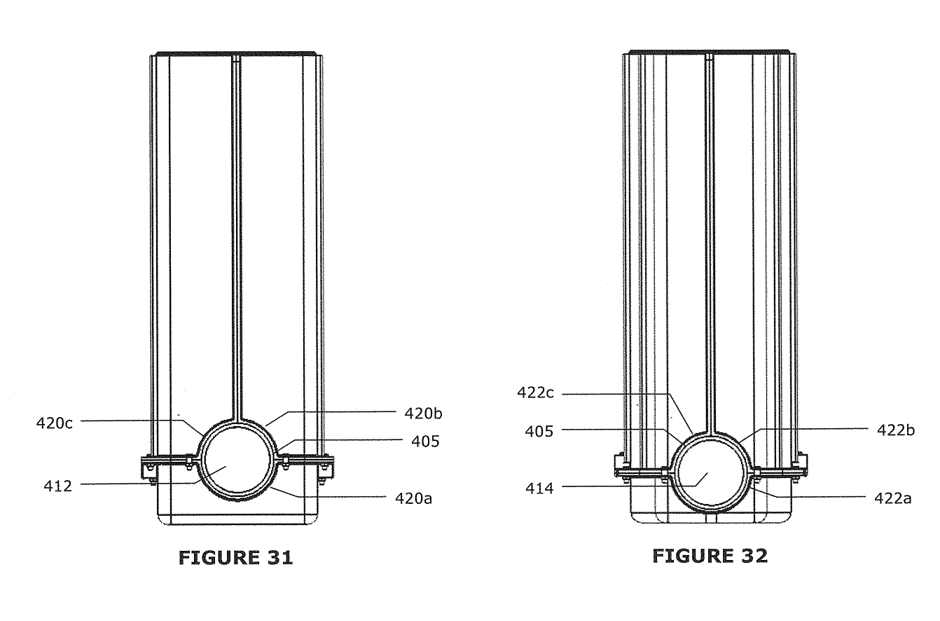

As can be seen in FIG. 2, the housing pan 102 of check valve access chamber 100 is provided as a single piece. However, in other embodiments, the housing pan can be constructed from two or more pan pieces which join together to form the housing pan 102. For example, in check valve access chamber 300 (FIGS. 17-24), the housing pan is divided into pan pieces 302a and 302b. Pan pieces 302a and 302b can then be joined as front and back halves to form a housing pan. By way of further example, in check valve access chamber 400 (FIGS. 25-32), the housing pan is divided into pan pieces 402a, 402b, and 402c. Pan pieces 402a, 402b, and 402c can then be joined to form a housing pan. Other arrangements of pan pieces are also contemplated, such as top and bottom halves or left and right pan pieces.

The joining of pan pieces to form a housing pan may form part of either the manufacturing process or the installation process. Such joining may also include the creation of a seal between the pan pieces, by way of a gasket, pressure fit, adhesive, or any other sealing means known in the art. For example, the arrangement of pan pieces in access chamber 400 permits the installation of check valve access chamber 400 over a self-contained check valve assembly 124 which has already been installed on the inlet and outlet pipes 116, 118. The use of flexible materials on one or more of these pan pieces can assist in such installations. In other embodiments, a single flexible pan piece may be provided with cuts extending from the first and second apertures 112 and 114 to an outer edge so as to permit flexing of the pan over the attached inlet and outlet pipes 116 and 118.

As can be seen in FIG. 3, the access sleeve 104 in check valve access chamber 100 extends from the housing pan 102 in an upright orientation and provides access to the self-contained check valve assembly 124 from above. The access sleeve 104 in access chamber 100 extends upwards at a single angle of about 90 degrees (FIG. 3); however, in other embodiments, the access sleeves can connect to the housing pan 102 at more than one angle (not shown), thereby permitting installation of the access sleeve 104 at an angle suitable for the particular application.

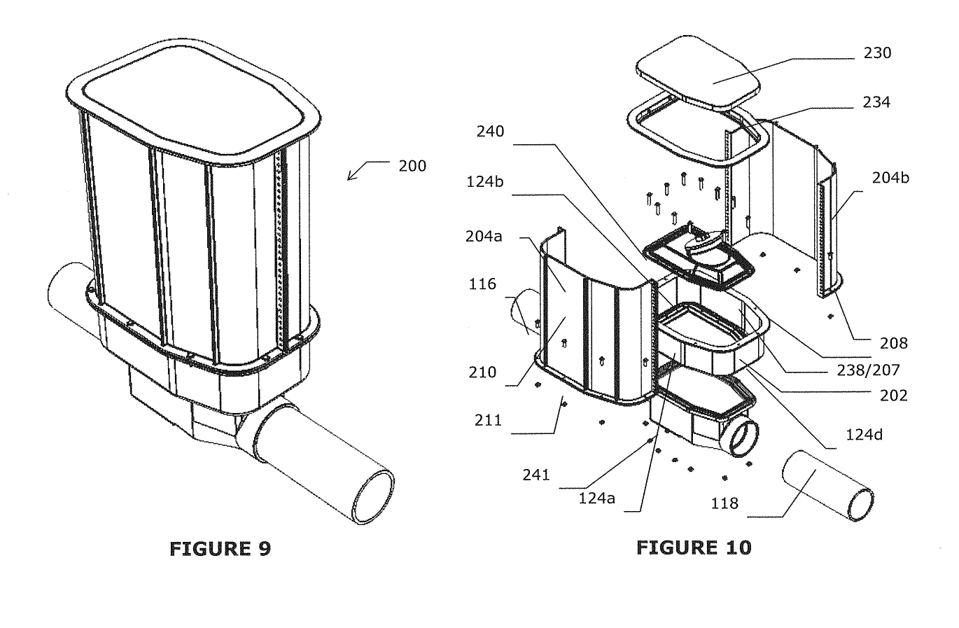

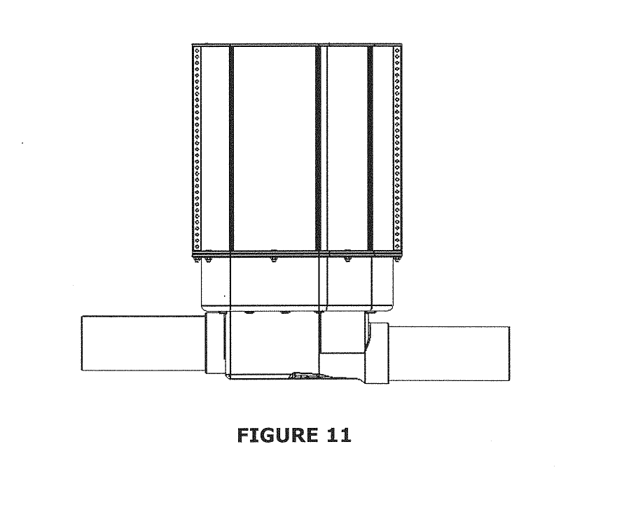

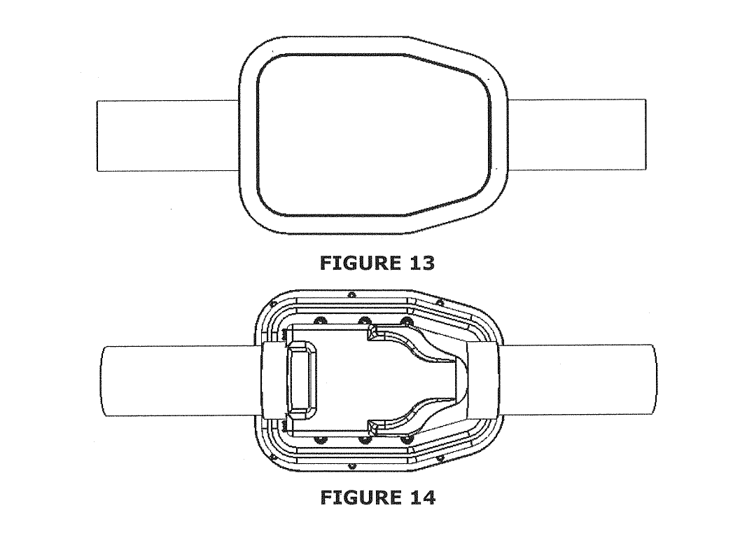

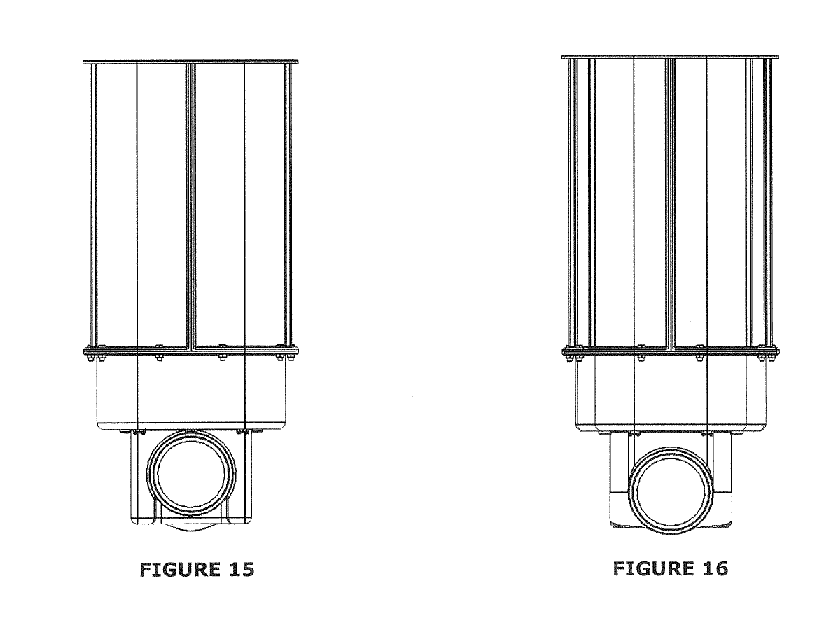

As can be seen in FIG. 2, the access sleeve 104 of check valve access chamber 100 is provided as a single piece. However, in other embodiments, the access sleeve can be constructed from two or more sleeve pieces which join together to form an access sleeve. For example, in check valve access chambers 200 and 400 (FIGS. 9-16 and 25-32, respectively), the access sleeve is provided as two sleeve pieces 204a/204b and 404a/404b. The joining of such sleeve pieces to form an access sleeve may form part of either the manufacturing process or the installation process. Such joining may also include the creation of a seal between the sleeve pieces, by way of a gasket, pressure fit, adhesive, or any other sealing means known in the art.

The access sleeve can also be provided in various sizes and shapes. In check valve access chamber 100, the access sleeve 104 mirrors the footprint of the housing pan 102, which in turn mirrors the profile of the self-contained check valve 124. In other embodiments, such as access chambers 500 and 600 (FIGS. 33-40 and 41-48, respectively), the access sleeves 504, 604 are substantially rectangular in shape. A variety of other appropriate shapes and sizes would also be apparent to a person of skill in the art, including round, oval, or various polygonal access sleeve configurations.

The access sleeve is of a variable length such that it rises up from the self-contained check valve assembly 124 to the final grade for access. In check valve access chamber 100, variations in length can be achieved by providing an access sleeve 104 made of a material suitable for on-site trimming by the tradesperson performing the installation. Such materials include, but are not limited to, ABS (acrylonitrile butadiene styrene) plastic, PVC (polyvinyl chloride) or other thermoplastics and plastics. Alternatively, or in conjunction with trimming, the access sleeve 104 can also be provided in varying pre-defined lengths.

As seen in FIG. 1, check valve access chamber 100 is further provided with a removable lid 130 to cover the opening 132 of the access sleeve 104. However, since sewer gasses are contained by the self-contained check valve assembly 124, a removable lid 130 is not required per se, but is a useful means by which to prevent accidental entry of materials or persons into the check valve access chamber 100 after installation.

In access chamber 100, the removable lid 130 rests in a lid frame 134, which is secured to the access sleeve 104 by screws (not shown) or other fastening means. Although not required, the lid frame 134 provides added rigidity to the access sleeve 104, added strength to the lid 130, and an even surface for the lid 130 to rest upon (or be secured to) after trimming the access sleeve 104 to length. In other embodiments, such as access chamber 300 (FIGS. 17-24), the lid frame can be omitted.

As can be seen in FIG. 4, pipe seal 105 and sleeve seal 106 provide a sealed enclosure around the self-contained check valve assembly 124, which can be accessed from above via the access sleeve 104. Access chamber 100 is therefore suitable to be buried under soil, gravel, cement, or other backfill to a desired grade. The access sleeve 104 can then be trimmed to a desired height relative to the desired grade of fill and the self-contained check valve assembly 124 remains accessible from above despite being below grade.

FIGS. 9-16 provide a check valve access chamber 200 according to another embodiment of the invention contemplated herein. As seen in FIG. 10, in this embodiment, the self-contained check valve assembly 124 is separated into its primary valve housing 124a and its valve lid 124b. The housing pan 202 lacks a housing pan bottom. Rather than enclosing the self-contained check valve 124, the housing pan 202 in check valve access chamber 200 is designed to seal against the self-contained check valve assembly 124. Thus, the pipe seal 105 is replaced by a pan seal 207.

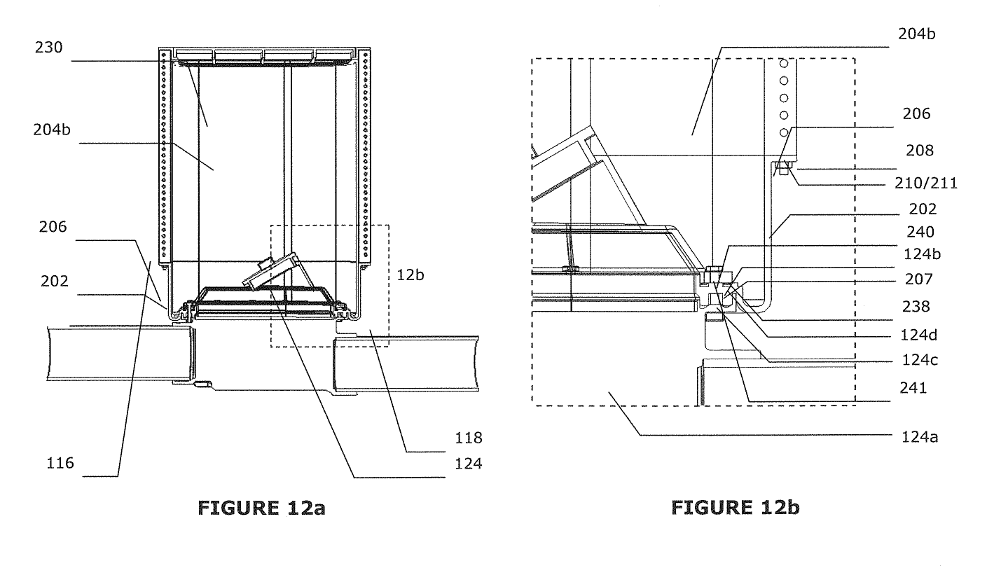

As can seen in FIG. 12b, the housing pan 202 is provided with valve flanges 238 which are disposed between the primary valve housing 124a and the valve lid 124b. The assembly is secured by bolts 240 and nuts 241 passing through apertures 276 in the valve flange 238 which align with corresponding apertures in the primary valve housing 124a and valve lid 124b. Two seals are thereby created. The first seal is the pan seal 207, which is formed between the valve flange 238 and the valve lid 124b. The second seal is the valve lid seal 124d, which is formed between the valve lip 124c of the primary valve housing 124a and the valve flange 238. In check valve access chamber 200, pan seal 207 and valve lid seal 124d are formed by gaskets. Other forms of seal are known in the art, and can be substituted as appropriate.

The remaining components of check valve access chamber 200 shown in FIGS. 9-16 are similar to the components of check valve access chamber 100 shown in FIGS. 1-8 above. Similar parts have therefore been labelled with similar numerals in the 200 series (e.g. 102=202; 130=230; etc).

FIGS. 17-24 provide a check valve access chamber 300 according to yet another embodiment of the present invention. As was the case in check valve access chamber 200, the housing pan in check valve access chamber 300 is designed to seal against the self-contained check valve assembly 124 rather than enclosing it completely. However, in check valve access chamber 300 the housing pan is divided into first and second pan pieces 302a, 302b which join to form a housing pan lacking a housing pan bottom.

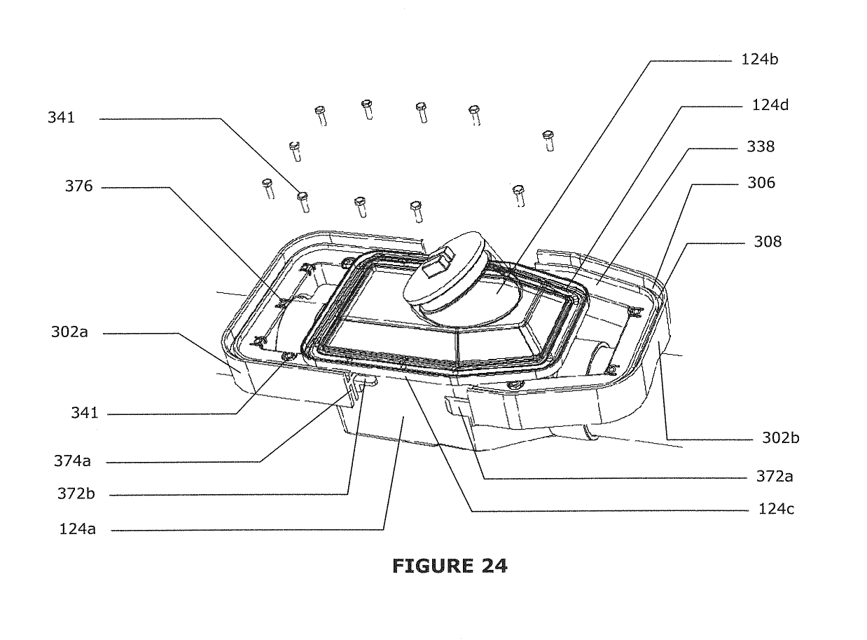

As can be seen in FIG. 24, pan pieces 302a and 302b slidably engage each other to form the housing pan. Although not required, check valve access chamber 300, also includes pan piece tongues 372a and 372b and pan piece slots 374a and 374b, which are provided on each pan piece and interlock during engagement for added rigidity.

In check valve access chamber 300, pan pieces 302a and 302b are secured in place after joining by bolts 340 which pass through apertures 376 in the valve flange 338 and are held in place by nuts 341. In this embodiment, the valve flange 338 is further provided with recesses in a shape complementary to the nuts 341, so as to receive and retain the nuts 341. Various other forms of fastening means can also be used in place of nuts 341 and bolts 340, including adhesives, screws, nails, clips, snaps, click-lock features and clamps. The invention also contemplates creating a seal between pan pieces 302a and 302b, which can be accomplished using a variety of sealing means known in the art, including adhesives and gasket seals.

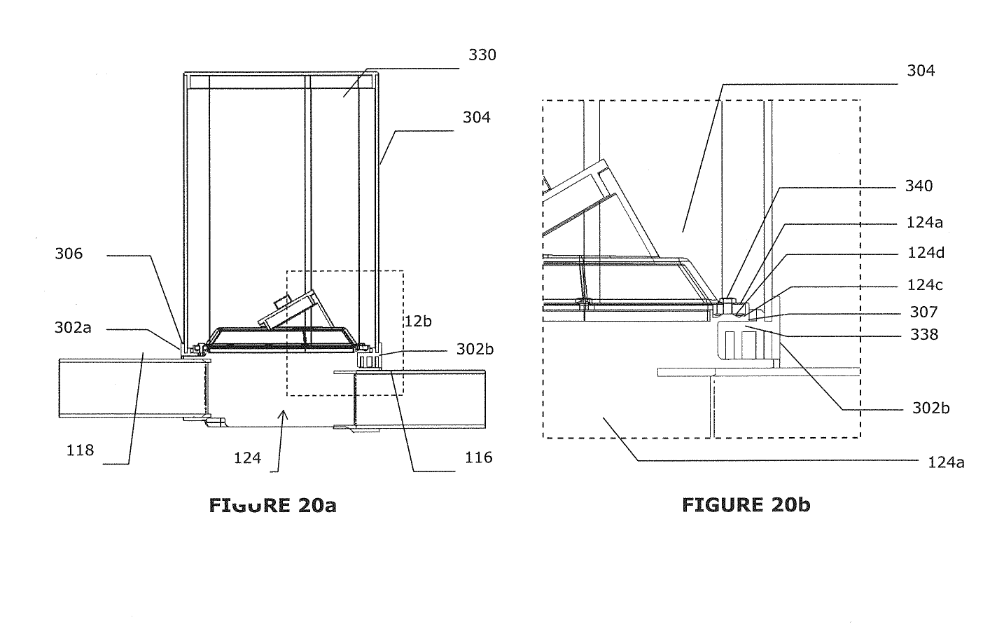

As can be seen in FIG. 20b, pan pieces 302a and 302b are provided with valve flanges 338 which slidably engage the underside of a valve lip 124c on the primary housing 124a of the self-contained check valve assembly 124. Thus, the valve lip 124c of the primary valve housing 124a is disposed between the valve lid 124b and the valve flange 338. The assembly is then secured as described above by bolts 340 passing through apertures 376, which are held in place by nuts 341. Thus, in this embodiment, the connection between the housing pan and the self-contained check valve assembly 124 does not interrupt the valve lid seal 124d between the valve lid 124b and the primary valve housing 124a. A pan seal 307 is provided between the valve flanges 338 and the valve lip 124c of the primary valve housing 124a. In check valve access chamber 300, pan seal 307 and valve lid seal 124d are formed by gaskets. Other forms of seal are known in the art, and can be substituted as appropriate.

The remaining components of check valve access chamber 300 shown in FIGS. 17-24 are similar to the components of check valve access chamber 200 shown in FIGS. 9-16 above. These similar parts have therefore been labelled with similar numerals in the 300 series (e.g. 202=302; 230=330; etc).

FIGS. 25-32 provide a check valve access chamber 400 according to yet another embodiment of the present invention. Like check valve access chamber 100, the housing pan of check valve access chamber 400 is designed to enclose the self-contained check valve assembly 124 rather than sealing against it. In this embodiment, the housing pan is split in to a lower pan piece 402a and two upper pan pieces 402b and 402c. The upper pan pieces 402b and 402c are integral with access sleeve pieces 404a and 404b. These 3 are joined to form the housing pan and access sleeve, which in this embodiment, encloses the self-contained check valve assembly 124. Preferably, the joining of these pieces forms part of the installation process, and is accompanied by sealing the pieces against one another using techniques known in the art, including gaskets, welding, pressure fits, adhesives, or other sealing means.

The division of the housing pan into three pan pieces occurs along the first and second apertures 412, 414 requires that the first and second pipe flanges be divided into three parts 420a, 420b, 420c, and 422a, 422b, 422c corresponding to each piece of the housing pan. These first and second pipe flanges are then sealed against the inlet and outlet pipes, respectively, at a pipe seal 405. As discussed above with regard to check valve access chamber 100, a number of alternative pipe seals 405 are contemplated within the scope of the present invention.

The remaining components check valve access chamber 400 shown in FIGS. 25-32 are similar to the components of check valve access chamber 100 shown in FIGS. 1-8 above. These similar parts have therefore been labelled with similar numerals in the 400 series (e.g. 102=402; 130=430; etc).

FIGS. 33-40 provide an access chamber 500 according to yet another embodiment of the present invention. Like check valve access chamber 100, the housing pan of check valve access chamber 500 is designed to enclose the self-contained check valve assembly 124 rather than sealing against it. In check valve access chamber 500, the housing pan 502 and access sleeve 504 are provided as a single, integral piece. Thus, the use of an integral pan and sleeve does away with the need for a sleeve seal.

As can be seen in FIG. 36, the pipe seals 505 are formed by first and second pipe flanges 520 and 522 are disposed inwardly toward the space formed by the housing pan 502 on the first and second apertures 512 and 514. However, as discussed above in relation to check valve access chamber 100, a number of alternative pipe seals 505 are contemplated as part of the invention. Finally, the housing pan floor 528 is elevated so as to support the self-contained check valve assembly 124 in a position relative to the first and second apertures 512 and 514.

The remaining components of check valve access chamber 500 shown in FIGS. 33-40 are similar to the components of check valve access chamber 100 shown in FIGS. 1-8 above. Similar parts have therefore been labelled with similar numerals in the 500 series (e.g. 102=502; 530=330; etc).

FIGS. 41-48 provide an access chamber 600 according to yet another embodiment of the present invention. Like check valve access chamber 500, the housing pan of check valve access chamber 600 is designed to enclose the self-contained check valve assembly 124 rather than sealing against it.

As can be seen in FIG. 44, and as described above, the first and second pipe flanges 620 and 622 are provided at an angle relative to level so as to establish and maintain a grade across the inlet and outlet pipes 116 and 118. In this embodiment, housing pan floor 628 is also provided at an angle relative to level so as to establish and maintain a grade across the self-contained check valve assembly 124.

As can be seen in FIG. 42, the pipe seals 605 at the first and second apertures 612 and 614 are formed in this embodiment by flexible rubber caps 650 secured by pipe clamps 652. Other types of pipe seal 605 are also contemplated, and known to a person of skill in the art.

The remaining components of check valve access chamber 600 shown in FIGS. 41-48 are similar to the components of check valve access chamber 500 shown in FIGS. 33-40 above. Similar parts have therefore been labelled with similar numerals in the 600 series (e.g. 502=602; 530=630; etc).

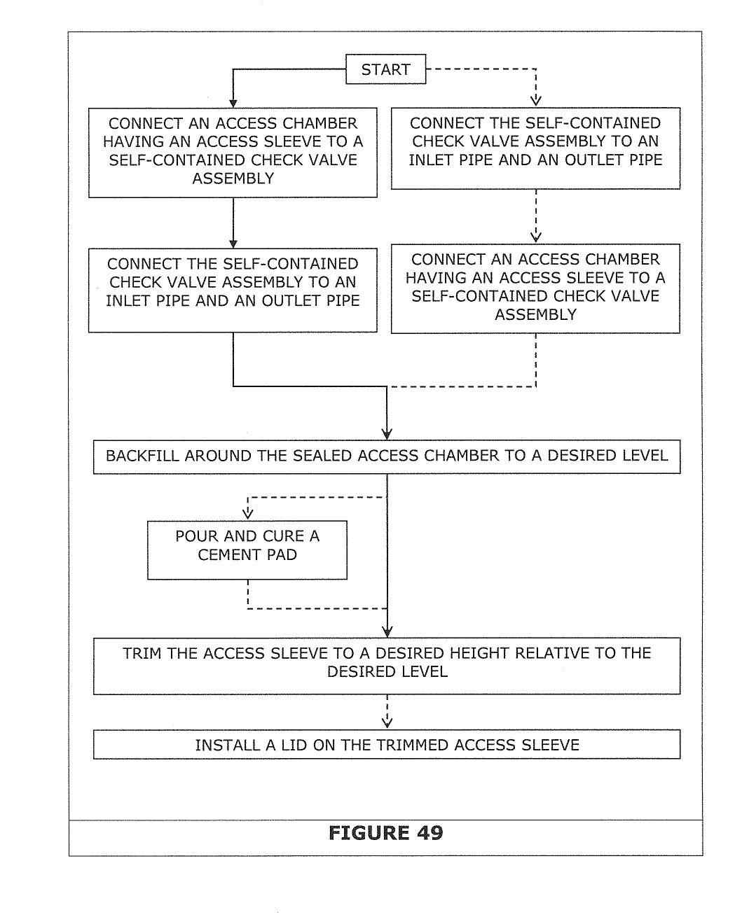

In operation, a check valve access chamber as contemplated in this invention permits a labour-saving method of installing a self-contained check valve assembly prior to backfilling or grading. FIG. 49 provides a block diagram outlining several such methods of installation. In some embodiments, the method utilizes an access chamber which encloses the self-contained check valve assembly. In other embodiments, the access chamber sealably connects to a self-contained check valve assembly.

Briefly, the method includes the steps of: connecting an access chamber having an access sleeve to a self-contained check valve assembly; connecting the self-contained check valve assembly to an inlet pipe and an outlet pipe; backfilling around the access chamber to a desired grade; and trimming the access sleeve to a desired height relative to the desired grade.

Accordingly, a check valve access chamber according to the present invention is connected to a self-contained check valve assembly. This connection can be made by enclosing the self-contained check valve assembly in the housing pan, as seen in check valve access chambers 100, 400, 500, and 600, or by way of attaching the check valve access chamber to the primary housing of the check valve assembly via a valve flange on the housing pan, as seen in check valve access chambers 200 and 300. In embodiments where the access sleeve is not integral with the housing pan, it is generally preferable to connect the access chamber to the self-contained check valve before installation of the access sleeve, however, the method also contemplates installing the access sleeve afterwards.

The self-contained check valve assembly is then connected to the inlet pipe and the outlet pipe to establish the connection to the plumbing system and the area around the check valve access chamber is backfilled to a desired grade and the access sleeve can be trimmed to a desired height above the grade.

As indicated in FIG. 49, additional steps can also be undertaken as part of the method. For example, the step of backfilling can be followed by pouring and curing a cement pad. Similarly, the step of trimming the access sleeve can be followed by installing a lid on the trimmed access sleeve, which may or may not involve installing a lid frame as described above. Finally, where necessary, the joining of pan pieces to one another, sleeve pieces to one another, the housing pan to the access sleeve, and the check valve access chamber to the inlet and outlet pipes can be accompanied by sealing said joints, so as to prevent seepage of waste water or sewer gasses.

The order of some of these steps can also be varied in the method. For example, in some embodiments, such as check valve access chambers 200, 300, and 400, the step of connecting the self-contained check valve assembly to the inlet and outlet pipes can occur before the access chamber is connected to the self-contained check valve assembly.

The embodiments of the present application described above are intended to be examples only. Those of skill in the art may effect alterations, modifications and variations to the particular embodiments without departing from the intended scope of the present application. In particular, features from one or more of the above-described embodiments may be selected to create alternate embodiments comprised of a subcombination of features which may not be explicitly described above. In addition, features from one or more of the above-described embodiments may be selected and combined to create alternate embodiments comprised of a combination of features which may not be explicitly described above. Features suitable for such combinations and subcombinations would be readily apparent to persons skilled in the art upon review of the present application as a whole. The subject matter described herein and in the recited claims intends to cover and embrace all suitable changes in technology.

What is claimed:

1. A check valve access chamber comprising:
a housing pan sealably connectable to a self-contained check valve assembly; and
an access sleeve capable of being trimmed to a variable length, sealably connectable to the housing pan in a substantially upright orientation for providing access to said self-contained check valve assembly.

2. The check valve access chamber of claim 1 wherein the substantially upright orientation of the access sleeve is adjustable to at least two angles relative to level.

3. The access chamber of claim 1 wherein the housing pan is divided into at least two connectable pan pieces.

4. The access chamber of claim 3 wherein the self-contained check valve assembly has a lip, the underside of which is engaged by the at least two connectable pan pieces.

5. A check valve access chamber comprising:
a housing pan for supporting a self-contained check valve assembly;
a first aperture disposed on a first side of the housing pan for receiving an inlet pipe;
a second aperture disposed on a second side of the housing pan for receiving an outlet pipe; and
an access sleeve capable of being trimmed to a variable length connected to the housing pan in a substantially upright orientation for providing access to the self-contained check valve assembly;
wherein the housing pan and the access sleeve form a sealed enclosure.

6. The access chamber of claim 5 further comprising:
a first pipe flange disposed along the first aperture; and
a second pipe flange disposed along the second aperture;
wherein the first and second pipe flanges are provided at an angle relative to level for maintaining a grade along the inlet pipe and the outlet pipe.

7. The access chamber of claim 5 wherein the floor of the housing pan is angled relative to level for maintaining a grade along the self-contained check valve assembly.

8. The access chamber of claim 5 wherein the housing pan is divided into at least two connectable pan pieces.

9. The access chamber of claim 8 wherein the self-contained check valve assembly includes a lip, the underside of which is slidably engaged by the at least two connectable pan pieces.

10. The access chamber of claim 8 wherein at least one pan piece is flexible.

11. The access chamber of claim 5 wherein the access sleeve is divided into at least two connectable access sleeve pieces.

12. The access chamber of claim 5 wherein the orientation of the access sleeve is adjustable to at least two angles relative to level.

13. The access chamber of claim 5 wherein the housing pan and access sleeve are integrally connected.

14. A method of installing a check valve comprising the steps of:
connecting an access chamber having an access sleeve to a self-contained check valve assembly;
connecting the self-contained check valve assembly to an inlet pipe and an outlet pipe;
backfilling around the access chamber to a desired grade; and
trimming the access sleeve to a desired height relative to the desired grade.

15. The method of claim 14 wherein the access chamber fully encloses the self-contained check valve assembly.

16. The method of claim 14 wherein the access chamber sealably connects to a self-contained check valve assembly.

17. The method of claim 14 wherein the step of backfilling is followed by pouring and curing a cement pad.

18. The method of claim 14 wherein the step of trimming the access sleeve is followed by installing a lid on the trimmed access sleeve.

19. The method of claim 14 wherein the access chamber is connected to the self-contained check valve assembly after the sewer self-contained check valve assembly is connected to the inlet and outlet pipes.
